(19) United States
(12) Patent Application Publication
(10) Pub. No.: US 2025/0150920 A1
(43) Pub. Date: May 8, 2025

(54) COMMUNICATION APPARATUS, CONTROL METHOD, AND STORAGE MEDIUM

(71) Applicant: CANON KABUSHIKI KAISHA, Tokyo (JP)

(72) Inventor: TOSHIYUKI NAKAGAWA, Kanagawa (JP)

(21) Appl. No.: 19/012,390

(22) Filed: Jan. 7, 2025

Related U.S. Application Data
(63) Continuation of application No. PCT/JP2023/023250, filed on Jun. 23, 2023.

(30) Foreign Application Priority Data
Jul. 8, 2022 (JP) 2022-110740

(51) Int. Cl. H04W 36/22; H04W 28/08; H04W 28/16

(52) U.S. Cl. CPC H04W 36/22; H04W 28/08; H04W 28/16

(57) ABSTRACT

A communication apparatus transmits, to a server, an inference request including all or part of information about wireless channel quality, information indicating conditions of loads of a plurality of access points, information about characteristics of traffic, and time-series data on any of the foregoing pieces of information in a unit of time. The inference request requests inference of quality of communication with another communication apparatus in a case where traffic steering processing for tuning at least any one of a connection state and a communication path between the communication apparatus and another communication apparatus is executed. The communication apparatus acquires an inference result for the quality of the communication from the server, determines whether to execute the traffic steering based on the inference result, and provides information about change of the communication to the another communication apparatus in a case where the traffic steering is determined to be executed.

### CROSS-REFERENCE TO RELATED APPLICATIONS

This application is a Continuation of International Patent Application No. PCT/JP2023/023250, filed Jun. 23, 2023, which claims the benefit of Japanese Patent Application No. 2022-110740, filed Jul. 8, 2022, both of which are hereby incorporated by reference herein in their entirety.

### BACKGROUND

### Technical Field

The present disclosure relates to a communication apparatus compliant with the Institute of Electrical and Electronics Engineers (IEEE) 802.11 standard.

### Description of the Related Art

The standard of IEEE 802.11 series has been known as a communication standard relating to a wireless local area network (hereinafter, also called “WLAN”). In the latest standard, IEEE 802.11be, communication with high-peak throughput and low latency is implemented through a multi-link technique (Japanese Patent Application Laid-Open No. 2018-50133).

In a standard as a successor to IEEE 802.11, the introduction of artificial intelligence (AI) and machine learning (ML) is being considered.

In an environment where a plurality of wireless access points (hereinafter called “AP”) is present, a communication efficiency can be presumably improved by connecting stations (hereinafter, called “STA”) in a distributed manner to APs having low loads while avoiding APs with high loads to which many STAs are connected. Thus, it is expected that STAs are appropriately distributed to be connected to APs, in view of the communication characteristics to be provided for the services used by the STAs. Through this distribution processing, efficiency can be presumably improved for the entire network while providing, to the respective STAs, the network having communication characteristics necessary for the corresponding STA. The technique for tuning a connection state and/or a communication path in view of the efficiency and the communication characteristics is called “traffic steering”.

### SUMMARY

While machine learning is presumably employed for optimization of traffic steering in wireless communication, in typical techniques, none of a frame structure to be used for collecting data, a data collection method, and a method for using learning data, for implementation of the machine learning through roaming, is present.

In view of the above, one aspect of the present disclosure is to realize data collection to be used for machine learning for traffic steering and data communication therefor. Another aspect of the present disclosure is to realize traffic steering appropriate for communication based on the collected data.

According to an aspect of the present disclosure, a communication apparatus includes at least one memory storing instructions, and at least one processor configured to execute the instructions stored in the at least one memory to cause the communication apparatus to transmit, to a server, an inference request including all or part of information about quality of a wireless channel, information indicating conditions of loads of a plurality of access points, information about a characteristic of traffic, and time-series data on any of the foregoing pieces of information in a unit of time, wherein the inference request requests inference of quality of communication with another communication apparatus in a case where traffic steering processing for tuning at least any one of a connection state and a communication path between the communication apparatus and the another communication apparatus is executed, acquire a result of inference of the quality of the communication from the server, determine whether to execute the traffic steering based on the result of the inference, and provide information about change of the communication to the another communication apparatus in a case where the communication apparatus determines to execute the traffic steering.

Further features of the present invention will become apparent from the following description of exemplary embodiments with reference to the attached drawings.

### BRIEF DESCRIPTION OF THE DRAWINGS

FIG. 1 is a diagram illustrating an example of a network configuration.

FIG. 2 is a block diagram illustrating an example of a hardware configuration of an access point (AP) and a station (STA).

FIG. 3 is a block diagram illustrating an example of functional block configurations of the AP and the STA.

FIG. 4 is a diagram illustrating a concept of a structure using a learning model generated from input data, a learning model, and output data.

FIG. 5 is a diagram illustrating an example of a processing in the entire system.

FIG. 6 is a flowchart illustrating an example of processing executed by the AP.

FIG. 7 is a flowchart illustrating an example of processing executed by a data collection server.

FIG. 8 is a flowchart illustrating an example of processing in a learning phase executed by an inference server.

FIG. 9 is a flowchart illustrating an example of processing in an inference phase executed by the inference server.

### DESCRIPTION OF THE EMBODIMENTS

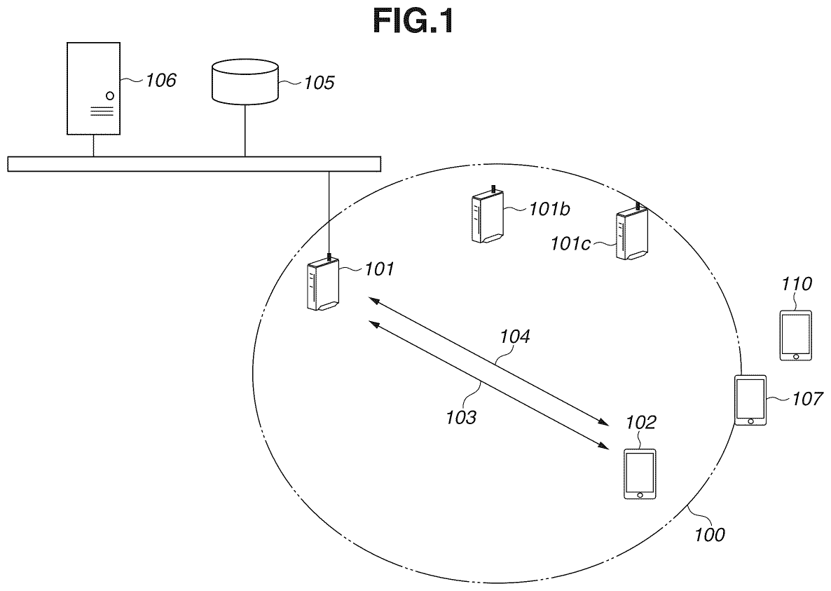

A first exemplary embodiment of the present disclosure will be described below. FIG. 1 is a diagram illustrating an example of a network configuration according to the first exemplary embodiment. A wireless communication system in FIG. 1 includes access points (AP) 101, 101b, and 101c, stations (STA) 102, 107, and 110, a data collection server 105, and an inference server 106. The AP has functions similar to the functions of the STA except for a point that the AP has a relay function, so that the AP is also one type of the STA.

A circle 100 illustrates an area where a signal transmitted from the AP 101 is reachable, so that the STA included in the circle 100 can communicate with the AP 101. In the present exemplary embodiment, the AP 101 and the STA 102 can execute wireless communication compliant with a standard as a successor to IEEE 802.11be targeted for a maximum transmission rate of 46.08 gigabits per second (Gbps). The successor standard aims to achieve a maximum transmission rate of 90 Gbps to 100 Gbps or over. The successor standard of IEEE 802.11be newly aims to support communication with high-reliability and low-latency. Taking these points into account, in the present exemplary embodiment, the standard targeted for the maximum transmission rate of 90 Gbps to 100 Gbps or over, namely, the successor to IEEE 802.11b, is tentatively called IEEE 802.11 Ultra High Reliability (UHR).

The name “IEEE 802.11UHR” is provided for the sake of descriptive purposes based on the aims to be achieved through the successor standard and the key features of the successor standard, and it may be renamed once the standard is finalized. It is to be noted that the scope of the present specification and the attached patent claims can essentially be applied to all of successor standards of IEEE 802.11be through which wireless communication can be supported.

The AP 101 establishes wireless links 103 and 104 with the STA 102 through predetermined association processing. While multilinked connection using two links is illustrated as an example in FIG. 1, the number of wireless links may be one, or two or more.

The AP 101 is connected to the data collection server 105 and the inference server 106 via the Internet. Any communication protocols can be used for connecting the AP 101 with the data collection server 105 and the inference server 106. In addition, the number of STAs and APs may be two or more.

In the present exemplary embodiment, as an example, the AP 101 functions as a controller in a mesh network including the APs 101, 101b, and 101c. The APs 101b and 101c function as agent apparatuses in the mesh network.

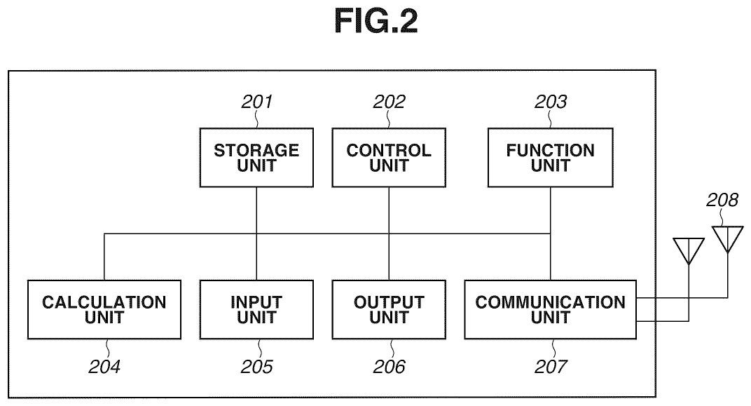

FIG. 2 is a block diagram illustrating a hardware configuration of the AP and the STA according to the present disclosure. For example, the hardware configuration includes a storage unit 201, a control unit 202, a function unit 203, a calculation unit 204, an input unit 205, an output unit 206, a communication unit 207, and an antenna 208.

The storage unit 201 includes memories such as a read only memory (ROM) and a random-access memory (RAM), and stores various types of information such as programs for executing various operations described below and communication parameters for wireless communication. Storage media such as a flexible disk, a hard disk, an optical disk, a magneto optical disk, a compact disc read only memory (CD-ROM), a compact disc-recordable (CD-R), a magnetic tape, a non-volatile memory card, and a digital versatile disc (DVD) can also be used as the storage unit 201 in addition to the ROM and the RAM. The storage unit 201 may have a plurality of memories.

For example, the control unit 202 includes processors such as a CPU and a micro processing unit (MPU), an application specific integrated circuit (ASIC), a digital signal processor (DSP), and a field programmable gate array (FPGA). The control unit 202 controls the AP by executing the program stored in the storage unit 201.

The control unit 202 may control the AP in cooperation with a program and an operating system (OS) stored in the storage unit 201. A multi-core processor including a plurality of processors may function as the control unit 202 to control the AP.

The control unit 202 controls the function unit 203 to execute functions of the AP and predetermined processing such as image capturing, printing, and projection processing. The function unit 203 is hardware for causing the AP to execute predetermined processing.

For example, the calculation unit 204 includes processors such as a graphics processing unit (GPU) and a tensor processing unit (TPU), an ASIC, a DSP, and an FPGA. The calculation unit 204 is hardware which executes inference calculation using a result of the machine learning and executes calculation of the machine learning itself.

In the example illustrated in FIG. 1, the data collection server 105 and the inference server 106 that are to be used for machine learning are provided separately from the AP 101 and the STA 102. However, these functions may be built into the AP 101 and the STA 102. In such a case, the calculation unit 204 operates as hardware that executes inference calculation using a result of the machine learning and executes calculation of the machine learning itself.

The TPU is an example of a systolic array-type hardware processor specialized for machine learning. The TPU includes multiply-accumulate units and buffer registers adjacent to the multiply-accumulate units as calculation resources, and hardware-implemented activation functions. The TPU also includes an instruction decoder that interprets a TPU instruction to direct the flow of calculation and controls the calculation resources. The TPU functions as a neural processing unit (NPU).

These processors execute calculation in collaboration with the control unit 202, so that part of the calculation may be shared with each other. In comparison to the general processor such as the CPU, the GPU and the TPU can execute efficient calculation by processing a large volume of data through parallel processing. Thus, it is effective to execute processing with the GPU and the TPU in a case where learning is performed for a plurality of times by using a learning model such as a deep learning model. Thus, in the present exemplary embodiment, with respect to the processing to be executed by a training unit included in the inference server 106, the GPU is used for the calculation unit 204 in addition to the control unit 202. Specifically, in a case where a learning program including a learning model is to be executed, learning is executed by the control unit 202 or the calculation unit 204 cooperatively executing calculation. With respect to the processing executed by the training unit, calculation may be executed by only the control unit 202 or only the calculation unit 204. As with the training unit, an inference unit may also use the calculation unit 204.

The input unit 205 receives various types of operation performed by the user. The output unit 206 outputs various types of information to the user. The information output from the output unit 206 includes at least any one of display on a screen, sound output from a speaker, and vibration output. Both the input unit 205 and the output unit 206 may be implemented by one module such as a touch panel.

The communication unit 207 executes encoding, decoding, modulation/demodulation processing of wireless communication data compliant with the standard of IEEE 802.11 series such as the standard of IEEE 802.11 EHT and its successor standard such as IEEE 802.11 UHR. The communication unit 207 executes wireless communication control compliant with Wi-Fi and Internet Protocol (IP) communication control. Further, the communication unit 207 controls the antenna 208 to transmit and receive a wireless signal for wireless communication.

As illustrated in FIG. 1, in a case where the data collection server 105 and the inference server 106 used for machine learning are provided separately from the AP 101 and the STA 102, each of the servers 105 and 106 includes a von Neumann-type computer. More specifically, each of the servers 105 and 106 includes one or more memories and one or more processors that equivalent to the control unit 202 and calculation resources such as the GPU and the TPU that equivalent to the calculation unit 204. In this case, the GPU and the TPU included in each of the servers 105 and 106 operate as the hardware that executes inference calculation using a result of the machine learning and executes calculation of the machine learning itself.

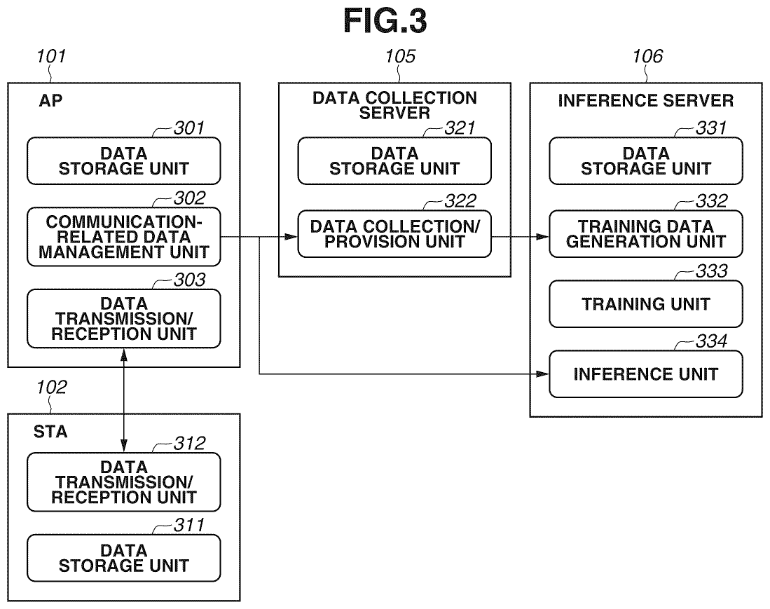

FIG. 3 is a functional block diagram of a learning system according to the present disclosure. The STA 102 includes a data transmission/reception unit 312. The data transmission/reception unit 312 transmits and receives the information about the surroundings collected by the communication unit 207, the information about the STA 102 itself, and the information accumulated in the storage unit 201 through the communication unit 207 and the antenna 208. A data storage unit 311 uses the storage unit 201.

The AP 101 includes a data transmission/reception unit 303. The data transmission/reception unit 303 receives data transmitted from the STA 102, and transmits data to the STA 102 from the AP 101. This transmission and reception of data is executed using the communication unit 207 and/or the antenna 208. Furthermore, the AP 101 has a data storage unit 301 for storing data in the storage unit 201. The storage unit 201 and the control unit 202 are expanded, and the AP 101 has a communication-related data management unit 302. The communication-related data management unit 302 operates together with the data collection server 105 and the inference server 106 to transmit input data to be used for learning, receive an inference result, and transmit a request for the inference result.

The data collection server 105 accumulates data collected from the AP 101 and/or the other APs in a data storage unit 321. The data collection server 105 transmits the accumulated data to the inference server 106 with the data collection/provision unit 322 as appropriate.

The inference server 106 receives the acquired input information and the result data from the data collection server 105, and generates a learning model by using a training data generation unit 332 and a training unit 333. The generated learning model is stored in the data storage unit 331. In response to a request for an inference value from the AP 101, the inference server 106 calculates the inference value through an inference unit 334 by using a learning result, and returns a calculation result to the AP 101.

In a case where the functions of the data collection server 105 and the inference server 106 to be used for machine learning are built into the AP 101 or the STA 102, a single apparatus such as the AP 101 or the STA 102 has all of the functions illustrated in FIG. 3. In a case where the data collection server 105 and the inference server 106 used for machine learning are provided separately from the AP 101 and the STA 102, functions such as the collection function and the inference function are implemented by the servers 105 and 106 provided separately as described above. In FIG. 3, the separately-provided inference server 106 executes both learning and inference, but the present exemplary embodiment is not limited thereto. The inference processing may be executed by the AP 101. In this case, the inference server 106 transmits the trained model data generated based on the received input and output data to the AP 101. In this case, the AP 101 may have a function of the inference unit 334. The AP 101 stores the trained model data received from the inference server 106. The inference unit 334 of the AP 101 may calculate an inference value by using input data for inference which can be acquired from a surrounding environment where the AP 101 collects information and the operating condition, and the trained model data.

The training unit 333 may have an error detection unit and an update unit. The error detection unit acquires an error between teaching data and output data that is output from an output layer of a neural network depending on input data input to an input layer. The error detection unit may calculate the error between the teaching data and the output data output from the neural network using a loss function.

The update unit updates, based on the error obtained by the error detection unit, a connection weight coefficient between nodes of the neural network to reduce the error. For example, the update unit updates the connection weight coefficient with a backpropagation method. The backpropagation method is a method for reducing the error by adjusting connection weight coefficients between nodes of the neural network.

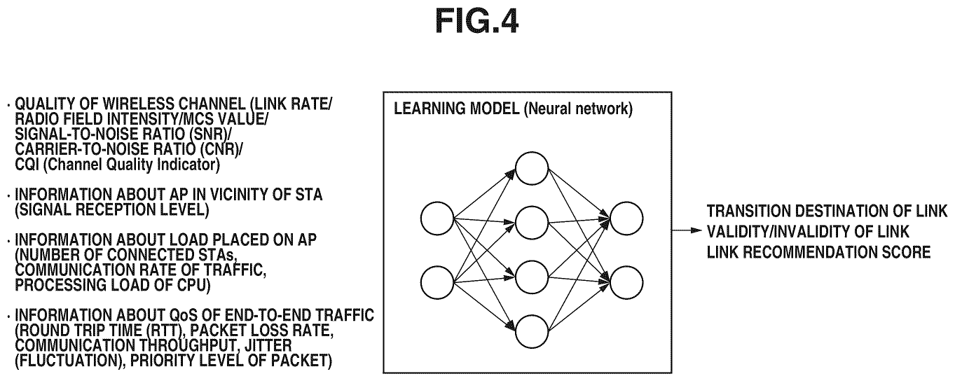

FIG. 4 is a conceptual diagram illustrating an input and output structure using a learning model according to the present exemplary embodiment. For example, information about quality of a wireless channel between the AP 101 and STA 102, information about an AP in the vicinity of the STA 102, load information indicating a condition of load placed on the AP 101, information about quality of service (QOS) of the end-to-end traffic, and priority levels of respective pieces of information are used as the input data input to the learning model. Examples of input data and output data input to/output from the learning model are illustrated in Table 1.

TABLE 1

| | Input Data | | | | | | | |
|---|---|---|---|---|---|---|---|---|
| | | | | | QoS of Traffic | | Output Data | |
| ID of | | | Information about | Statistics | (Latency, | | BSS ID of | |
| Learning | | STA | Communication | on BSS | Packet Loss | | Transition | |
| Data | BSS ID | ID | Quality | Load | Rate) | . . . | Candidate | . . . |

| | | | | | | | |
|---|---|---|---|---|---|---|---|
| 1 | AAAAA | 102 | | | . . . | | . . . |
| 2 | AAAAA | 107 | | | . . . | | . . . |
| 3 | BBBBB | 110 | | | . . . | | . . . |
| . . . | . . . | . . . | . . . | . . . | . . . | . . . | . . . |
| N | ZZZZZ | 197 | | | . . . | | . . . |

More specifically, examples of the information about the quality of a wireless channel of an STA that connects to the AP 101, such as the AP 101 and the STA 101 include one such as a link rate, radio field intensity, a modulation and coding scheme (MCS) value, and a signal-to-noise ratio (SNR). The MCS value is an indexed value of a combination of a modulation scheme and a coding rate. Further, a carrier-to-noise ratio (CNR) and a channel quality indicator (CQI) are also the information about quality of the wireless channel.

Information about the communication quality includes information about communication quality of an AP in the vicinity of the STA 102. For example, the information about communication quality of the AP in the vicinity of the STA is a received signal strength indicator (RSSI), which is a reception level of a signal that the STA 102 receives from a nearby AP.

Examples of the information about a load placed on the AP 101 include the number of connected STAs, a communication rate of traffic (of each STA and the total of all STAs), and information about a processing load placed on a CPU. The information about the load may include the condition of processing of data having a high packet priority level. The information about the load may include the condition of a transmission opportunity (TXOP) occurring in the network provided by the AP.

The information about QoS traffic includes for example information about round trip latency (RTT) at both ends of the network over which the STA 102 has performed communication, a packet loss rate, a communication throughput, jitter (fluctuation), and a priority level of a packet. These pieces of information are examples of the information about characteristics of traffic. The communication characteristics (i.e., appropriate throughput, reliability, and minimum latency) appropriate for the network service used by the user who owns the STA, which can be inferred and acquired from a priority level and a trend of traffic, may be included in the information about QoS of end-to-end traffic. The above-described pieces of information are examples of the information about characteristics of traffic.

The above-described information includes, for example, in a case where the user views a video image distributed by a streaming service through in the STA 102, information about actual traffic between the STA 102 and the server that executes video streaming, and information about a communication characteristic recommended for enjoying the intended service correspond.

In addition to the information about present time, statistical information within a predetermined period in the past may also be included in the above-described information. In other words, fluctuations in the above-described information in a predetermined time unit based on a certain time, specifically, time-series data on the above-described pieces of information, may be the input data used as input parameters. In the present exemplary embodiment, the time unit is assumed to be approximately one minute, as an example. However, the time unit is not limited thereto.

In the present exemplary embodiment, a transition recommendation score, information about a basic service set (BSS) of a link transition destination (i.e., a list of BSS transition candidates), and information about addition and/or deletion of a link between an STA and an AP are assumed to be the output data acquired by inputting the input data to the trained model.

In other words, through the inference according to the present exemplary embodiment, in addition to estimating the action to be taken next in order to improve the QoS value of the end-to-end traffic in the current situation, the recommendation score indicating a degree of improvement when that action is taken is also inferred.

The AP 101 executes processing for executing traffic steering in a case where the improvement is expected based on the output data. In a case where traffic steering is actually executed, the AP 101 records an actual measurement value acquired after traffic steering is executed, and accumulates the actual measurement value as data used for learning, update, and evaluation.

A characteristic of the input data is now described. The information about a quality of the wireless channel between an AP and an STA has a certain correlation with a communication throughput, occurrence of data latency, and reliability of data communication. For example, the worse the communication quality, the more likely the communication quality improves after traffic steering. The better the communication quality, the less likely it is that the communication quality improves with execution of traffic steering. The information about a load placed on the AP 101 has a certain correlation with the communication throughput and occurrence of data latency. For example, when a load is high before traffic steering is executed, the communication quality is likely to be improved after traffic steering is executed. When a load is low before traffic steering is executed, the communication quality is less likely to be improved after traffic steering is executed. For example, when a load placed on the AP 101 is low before traffic steering is executed, the communication quality is likely to be maintained even if the AP 101 accepts traffic of the STA originally assigned to another AP.

The information about QoS traffic has a certain correlation with the communication quality to be achieved after traffic steering. For example, in a case where a priority level of the current QOS is high but latency is high, appropriate communication quality is less likely to be ensured unless some sort of traffic steering is executed. For example, in a case where there is a disparity between the current QoS traffic and communication characteristics to be provided for the network service that is used by the user, appropriate communication quality is less likely to be ensured unless some sort of traffic steering is executed.

As described above, each of the input parameters has a certain trend toward the communication quality in the network. In the real space, whether the communication quality is improved traffic steering is determined depending on these parameters intricately linked to one another. However, since the parameters are intricately linked to one another, it is difficult to make the determination through the logical algorithms such as branch processing.

Meanwhile, by making an inference regarding whether traffic steering is to be performed and regarding candidates of an action to be next performed with a plurality of parameters having certain trends as an input, it is highly likely that whether traffic steering improves the communication quality is inferred. In consideration of the above, in the present exemplary embodiment, learning using the actual environmental parameters is executed with a combination of part of the above-described parameters or all of the parameters serving as input data.

The input data illustrated in Table 1 can be generated as follows. Initially, the STA transmits a status report including the communication quality to an AP such as the AP 101. The AP stores the quality of communication between the STA and the AP in association with time based on the status report and/or the information about communication parameters managed by the AP. The AP periodically monitors information indicating the load of the AP, and stores that information indicating the load of the AP in association with the time. The AP 101 functioning as a controller in the mesh network periodically collects radio wave conditions of the communication between STAs and APs in the vicinity of the STAs and the load information from the other APs, and stores the collected information in association with the time when the information is collected.

The AP 101 periodically transmits the information collected and stored by the AP 101 to the data collection server 105. Based on the data acquired from the APs and the STAs, the data collection server 105 generates metadata used for learning, and transmits the metadata to the inference server 106.

Based on the received metadata, a training data generation unit 332 of the inference server 106 generates a data set (a combination of an input data set and teaching data) for learning. The training data generation unit 332 combines various types of information acquired based on a time axis, and generates a data set indicating a network condition at a certain time point as illustrated in Table 1. Teaching data is the output data described above. The teaching data is data output when a favorable result is acquired as a result of traffic steering. A method for generating the teaching data is described below.

Examples of learning algorithms include algorithms such as nearest neighbors, Naive Bayes classifiers, decision trees, and support vector machines. Examples of learning algorithms further include deep learning which generates by itself a feature amount for learning and a connection weight coefficient by using a neural network. Any algorithm available from among the above-described algorithms can be used and applied to the present exemplary embodiment as appropriate.

The inference server 106 or the AP 101 inputs the current network condition to the trained model data and calculates candidates of traffic steering and a recommendation score.

In a case where traffic steering is actually executed, the AP 101, the data collection server 105, and the inference server 106 cooperatively stores the network conditions before and after execution of the traffic steering. The inference server 106 generates and accumulates the above data as evaluation data to be used to evaluate whether the trained model data can estimate appropriate traffic steering.

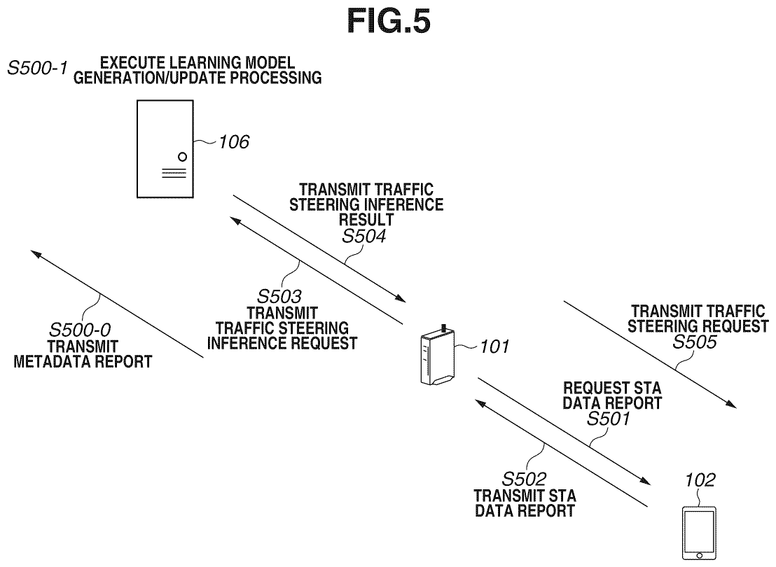

In a case where the trained model data has not been built because no data is accumulated, the communication system according to the present exemplary embodiment executes algorithm-based traffic steering that is previously defined and is a conventional method. The communication system then evaluates a result of traffic steering and creates teaching data. For example, the inference server 106 checks whether communication characteristics to be provided for the network service that is used by the user of the STA, which can be inferred and acquired from a priority level and a trend of traffic, are satisfied as a result of traffic steering. More specifically, the inference server 106 checks whether a throughput, reliability, and minimum latency time appropriate for the service are satisfied. The inference server 106 checks whether there is another negative effect on communication. In a case where the communication characteristics are satisfied and there is no negative effect, the inference server 106 stores information indicating that a result of traffic steering is favorable, details of traffic steering processing (e.g., information about BSS of a transition destination), and information about the time when the traffic steering is executed in association with each other. In a case where the inference server 106 determines that there is a negative effect or that a result of traffic steering is not favorable, the inference server 106 stores the information indicating that a result of traffic steering is not favorable. These pieces of data are used as teaching data when the model data is trained or updated. FIG. 5 is a diagram illustrating processing in the entire system using a structure of the learning model as illustrated in FIG. 4.

In step S500-0, the AP 101 and the other APs provide the metadata including information to be used for learning of traffic steering to the inference server 106 via the data collection server 105. In step S500-1, the inference server 106 executes generation and/or update processing (hereinafter, referred to as generation/update processing) of the learning model. The generation/update processing is executed based on the metadata accumulated in the inference server 106 and/or a data set obtained by combining pieces of information indicating effects of past roaming received in step S500-1. The generation/update processing is periodically executed at a timing when new data is accumulated for a predetermined times or more. In step S501 and the subsequent steps, inference processing using the generated or updated trained model will be described.

Initially, in step S501, the AP 101 requests a report of STA data from the STA 102 that is currently in connection to the AP 101. The STA data requested in step S501 is information about a quality of the wireless channel between the AP 101 and the STA 102 and information about an AP in the vicinity of the STA 102, specifically, information to be used for input data for learning and inference illustrated in FIG. 4. The AP 101 requests the information by using the Radio Measurement Request, the Link Measurement Request, and the Neighbor Report Request stipulated by IEEE 802.11k. IEEE 802.11k supports exchange of information related to a wireless communication environment executed by the AP and a client, and stipulates a system for transmitting information about nearby APs and a signal level of a channel. STA Report Request may be defined to collect learning data. In FIG. 5, only the STA 102 is connected to the AP 101. However, in a case where another STA not illustrated in FIG. 5 is also connected to the AP 101, the AP 101 similarly requests a report of STA data from the other STA.

In step S502, the STA 102 transmits the report of STA data in response to the request from the AP 101. For example, the information is transmitted by using the Radio Measurement Report, the Link Measurement Report, or the Neighbor Report Response stipulated by IEEE 802.11k. The STA Report Request and Response may be defined to collect data to be used for learning and inference. As a method for collecting information about the nearby APs, a method stipulated by the Wi-Fi Agile Multiband specifications can also be used. The STA 102 provides the information about the nearby APs to the AP 101 based on the above specifications. Information about communication quality is also included in the information about the nearby AP collected in step S502.

Next, in step S503, the AP 101 transmits a traffic steering inference request to the inference server 106. The report of STA data received from the STA 102 in step S502 and information about a load of the AP 101 are included in the traffic steering inference request.

The inference server 106 infers, based on the input data included in the traffic steering inference request transmitted from the AP 101, information about BSS of a transition destination of a link when traffic steering is executed (a list of BSS transition candidates), and returns the information as an inference result. In step S504, the inference server 106 also infers a recommendation score of the link and information about addition and/or deletion of a link between the STA 102 and AP 101, and returns results as an inference result to the AP 101.

The AP 101 determines whether to steer the traffic between the STA 102 and the AP 101 based on the traffic steering inference result received from the inference server 106. In a case where the AP 101 determines that traffic steering is to be performed, in step S505, the AP 101 transmits a traffic steering request to the STA 102 to steer the traffic between the STA 102 and the AP 101. In response to the STA 102 receiving the traffic steering request, the STA 102 performs the traffic steering on another AP based on the request. However, the STA 102 can determine by itself whether to follow the traffic steering request, and may omit to follow any of recommended traffic steering requests. Further, in a case where the STA 102 does not make a transition, the AP 101 may transmit the traffic steering request again after a certain period of time, or may forcibly cancel the connection with the STA 102. In a case where there are one or more STAs for which the AP 101 has determined that traffic steering is to be performed, the AP 101 transmits the traffic steering request to the one or more STAs.

In the present exemplary embodiment, the STA such as the STA 102 that is in connection to the AP 101 performs steering on another AP operating as a follower. The present exemplary embodiment is not limited thereto. For example, in a case where an inference result indicates that the traffic of an STA belonging to a follower AP (e.g., AP 101b) is to be steered to another AP (e.g., AP 101c), the AP 101 requests the traffic steering with respect to the STA. In this case, the AP 101 transmits the traffic steering request to a certain STA via the AP 101b serving as the follower. The traffic steering request is not limited to a request to change an access point, and can be a request to control a setting of an end-to-end multi-hop path. For example, in a case where low-latency high-throughput bidirectional communication is executed by devices in the mesh network, congestion in a main AP can be avoided by changing a communication path to another which does not go through the main AP.

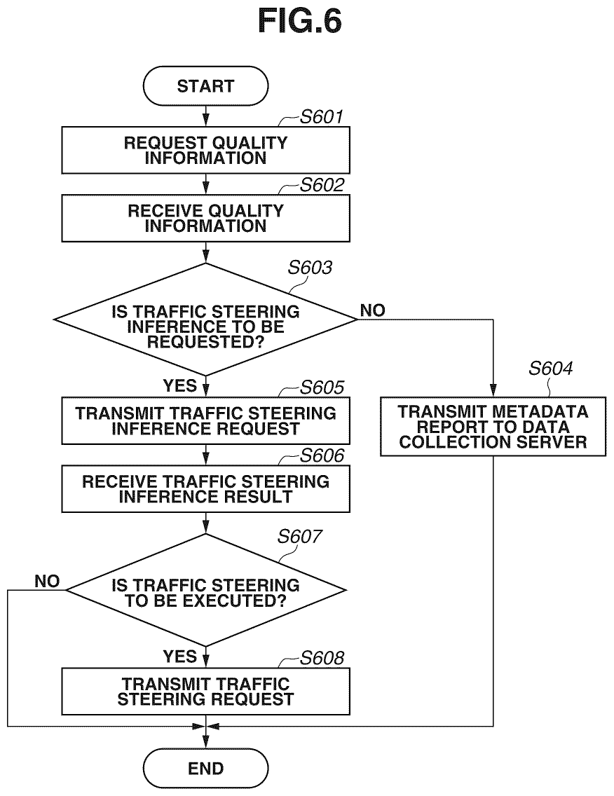

FIG. 6 is a flowchart illustrating the processing to be executed by the AP 101. This processing is periodically executed at a predetermined time period or a predetermined frequency after the AP 101 starts connecting to the STA 102, but this is not restrictive. The processing may also be executed in a case where the number of STAs in connection to the AP 101 exceeds a predetermined threshold, or in a case where the communication throughput exceeds a predetermined threshold. Furthermore, the processing may be executed in a case where the STA 102 transmits a BSS transition request to the AP 101 for a better communication environment. For example, the processing may be executed when the AP 101 receives the BSS Transition Management Query stipulated by IEEE 802.11v. In step S601, the AP 101 requests the STA 102 to transmit STA data including quality information. This processing is implemented through the operation in step S501 in FIG. 5. The AP 101 requests the follower AP to transmit AP data including quality information and load information.

Next, in step S602, the AP 101 receives the response to the request. This is implemented through the operation in step S502 in FIG. 5. Next, in step S603, the AP 101 determines whether to request the inference server 106 to execute traffic steering inference. For example, the AP 101 can execute the determination in step S603 based on whether a traffic steering function is enabled as a general setting with respect to the AP 101 and/or the mesh network. Alternatively, the AP 101 may automatically request traffic steering inference in a case where the number of STAs in connection to the AP, a CPU processing load of the AP, and/or a communication throughput of the AP exceed(s) respective predetermined thresholds. In other words, the processing illustrated in the flowchart may be executed in a case where some sort of event which can change a trend of the network traffic has occurred.

As a result of determination in step S603, in a case where the AP 101 determines not to request traffic steering inference (NO in step S603), the processing proceeds to step S604. In step S604, the AP 101 transmits the collected data to the data collection server 105, and ends the processing. The data transmitted in step S603 is used for training or updating the model data.

As a result of determination in step S603, in a case where the AP 101 determines to request traffic steering inference (YES in step S603), the processing proceeds to step S605. In step S605, the AP 101 transmits a traffic steering inference request to the inference server 106. Next, in step S606, the AP 101 receives a traffic steering inference result from the inference server 106. As described in step S503 in FIG. 5, a report of STA data received from the STA 102 and information about a load of the AP 101 or the follower AP are included in the traffic steering inference request. Even in a case where the AP 101 requests traffic steering inference, the AP 101 may transmit metadata to the data collection server 105 after receiving the inference result.

Next, in step S607, based on the received traffic steering inference result, the AP 101 determines whether to steer the traffic of the STA in connection to the AP 101 or to the follower AP. As a result of the determination in step S607, in a case where the AP 101 determines not to execute traffic steering (NO in step S607), the processing is ended. The inference processing based on the request in step S605 and the determination processing in step S607 are collectively called calculation processing. The information indicating whether to execute roaming, which is obtained through the calculation processing, is also called a calculation result.

As a result of determination in step S607, in a case where the AP 101 determines to execute traffic steering (YES in step S607), the processing proceeds to step S608. In step S608, the AP 101 transmits a traffic steering request to the STA 102. Here, Examples of a useable control method include the BSS Transition Management Request stipulated by IEEE 802.11v. IEEE 802.11v stipulates a method for using, in managing a wireless environment, measurement information stipulated by IEEE 802.11k, so that it is possible to control the operation of the STA. A method stipulated by the above-described Wi-Fi Agile Multiband specifications can also be used in addition to the method stipulated by IEEE 802.11v.

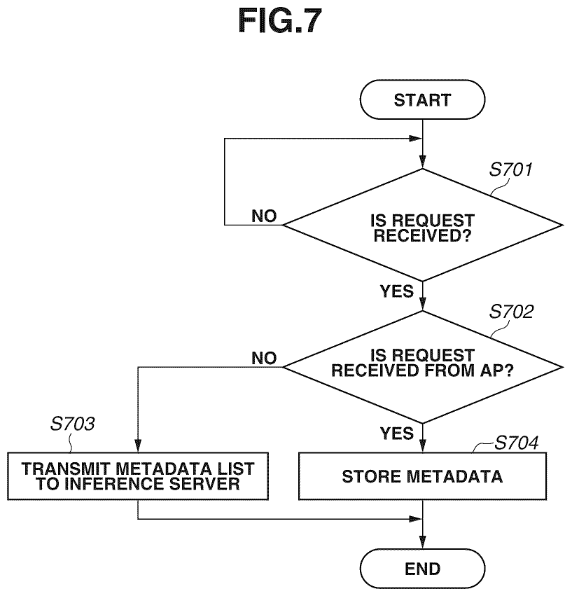

FIG. 7 is a flowchart illustrating the processing executed by the data collection server 105 at the time of learning and inference. This processing is constantly executed by the data collection server 105.

In step S701, the data collection server 105 waits for a request from the AP 101, the follower AP, or the inference server 106. In response to the data collection server 105 receiving a request (YES in step S701), the processing proceeds to step S702. In step S702, the data collection server 105 changes the processing depending on a transmission source of the request. In a case where the request is received from the inference server 106 (NO in step S702), the data collection server 105 determines that the request is one for a list of data for learning, and advances the processing to step S703. In step S703, the data collection server 105 transmits a list of metadata stored in the inference server 106. In a case where the request is received from the AP 101 or the follower AP (YES in step S702), the data collection server 105 determines that the request is a metadata storing request, and advances the processing to step S704. In step S704, the data collection server 105 stores the metadata. A determination criterion does not have to be the address of the transmission source. For example, details of the request may be described in a request frame.

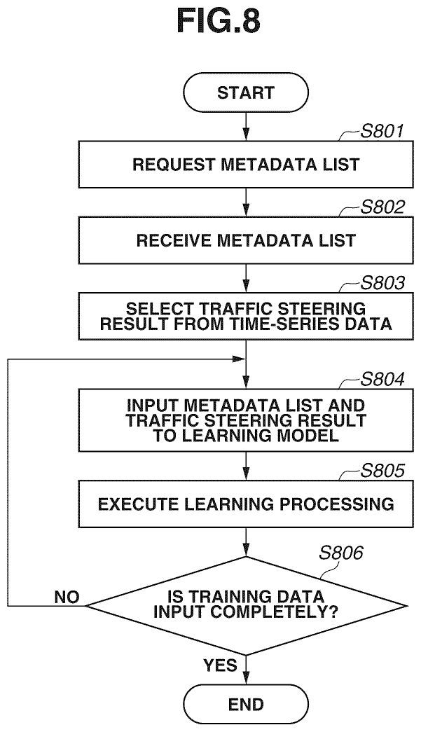

FIG. 8 is a flowchart illustrating the processing executed by the inference server 106 at the time of learning. The generation and update processing of the learning model is periodically executed by the inference server 106.

In step S801, the inference server 106 requests the data collection server 105 to transmit a metadata list. When the inference server 106 receives a metadata list from the data collection server 105 in step S802, in step S803, the inference server 106 generates a data set to be used for learning, from time-series data. The input data may be entire data of a certain continuous period. For example, the input data may be data of one day in a past, sampled and collected minute by minute.

In step S804, the inference server 106 inputs data sets to be used for learning to the learning model. In step S805, the training unit 333 of the inference server 106 executes learning processing of the model data based on the input parameters. For example, in a case where a learning model is to be built by using a neural network, the inference server 106 executes update processing of a connection weight coefficient between nodes of a convolutional neural network so that an output value of the neural network is close to a target value. The inference server 106 determines an adjustment amount for the connection weight coefficient by using an error function expressing information about an error between teaching data and the output value output by using the model data under the training.

Next, in step S806, the inference server 106 determines whether the data sets prepared in step S803 are input completely. In a case where the data sets are input completely (YES in step S806), a series of learning processing is ended. In a case where not all of the data sets are input (NO in step S806), the processing returns to step S804. In step S804, the inference server 106 continuously executes training of the model data based on the data sets that have not been input to the model. A connection weight coefficient is gradually optimized by repeatedly executing the operations in steps S804 and S805, and the trained model data that outputs an output value having a small error from the target value can be built.

Through the above-described processing, it is possible to build the trained model data for roaming processing.

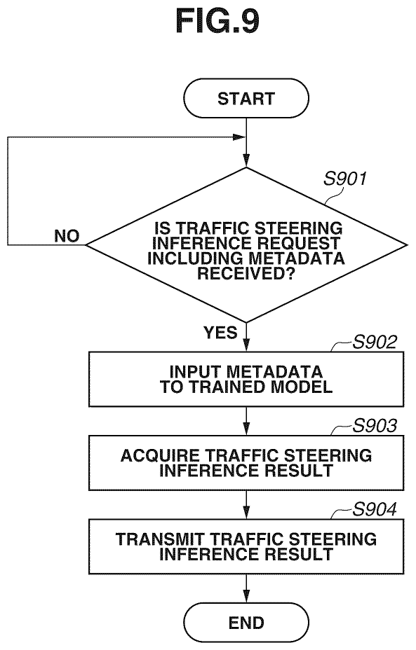

FIG. 9 is a flowchart illustrating the processing executed by the inference server 106 at the time of inference. It is assumed that inference is constantly executed by the inference server 106. As described above, the inference processing can be executed by the AP 101. In this case, the processing illustrated in FIG. 9 is executed by the AP 101 instead of the inference server 106.

In step S901, the inference server 106 initially determines whether a traffic steering inference request including metadata for input is received from the AP 101.

In a case where the traffic steering inference request is received (YES in step S901), the processing proceeds to step S902. In step S902, the inference server 106 performs input to the trained model based on the metadata for input. Here, in a case where the format of the received metadata is different from the format of input data, the inference server 106 converts the format of the metadata into one same as the format of input data by using the training data generation unit 332.

In step S903, the inference server 106 acquires a traffic steering inference result from the learning model. In step S904, the inference server 106 transmits the acquired inference result to the AP 101.

After the learning model is generated through the processing in FIG. 8, the inference server 106 may distribute an entire learning model to all of target APs. In such a case, the processing in FIG. 9 is internally executed by the AP 101. In this case, after the AP 101 acquires the traffic steering inference result, the AP 101 determines whether to perform the traffic steering on the communication with the STA 102, and notifies a result of the determination to the STA 102.

As described above, through the frame used for the standard of IEEE 802.11 described in the present disclosure, the AP 101 can determine whether traffic steering is to be performed with respect to the connected STA, and can transmit a notification to the STA when traffic steering is to be performed.

A destination to which traffic is transitioned through traffic steering is not limited to another AP. For example, it is possible to make a transition to a network of another frequency band provided by the same AP. The transition processing in the traffic steering according to the present exemplary embodiment includes transition processing such as band steering that changes a frequency band to which the STA is connected in a case where the AP supports a plurality of frequency bands (such as 2.4 GHz, 5 GHz, and 6 GHz).

### Variation Examples

In the present exemplary embodiment, a wireless communication system based on a mesh network is described as an example of the wireless communication system including a plurality of APs. However, the present exemplary embodiment is not limited thereto. For example, the wireless communication system may be intended for an enterprise in which a plurality of APs is managed and controlled by an access point controller. In such a case, the learning processing and the inference processing may be executed by the access point controller.

In the present exemplary embodiment, a standard named “IEEE 802.11UHR” has been described as one example of the standard as a successor to IEEE 802.11be. However, a name of the standard is not limited thereto. For example, the standard name may be IEEE 802.11 High ReLiability (HRL), IEEE 802.11High Reliability Wireless (HRW), IEEE 802.11 Very High Reliability (VHT), IEEE 802.11 Extremely High Reliability (EHR), or may simply be IEEE 802.11 High Reliability (HR). Further, the standard name may be IEEE 802.11 Low Latency (LL), IEEE 802.11 Very Low Latency (VLL), IEEE 802.11 Extremely Low Latency (ELL), or IEEE 802.11 Ultra Low Latency (ULL). Furthermore, the standard name may be IEEE 802.11 High Reliable and Low Latency (HRLL), IEEE 802.11 Ultra-Reliable and Low Latency (URLL), IEEE 802.11 Ultra-Reliable and Low Latency Communications (URLLC), or some other name.

### Other Exemplary Embodiments

Part of the data sets (combinations of input values and teaching data) that the training data generation unit 332 has generated for the purpose of learning can be used not only for the purpose of learning but also for the purpose of evaluating the performance of the trained data model. The inference server 106 intentionally refrains from using part of the data sets that the training data generation unit 332 has generated for learning, and separately stores these data sets as data sets to be used for evaluation. These data sets to be used for evaluation are combinations of input values and teaching data (correct data) that have not been used for learning in the past and are unknown to the trained model data.

In this case, the inference server 106 calculates an inference result by using the trained model data trained by the training unit 333 and input values of the data sets for evaluation. Subsequently, the inference server 106 evaluates the performance of the trained model by comparing the inference result and teaching data.

As a result of evaluation on the performance, in a case where a correct answer rate exceeds a predetermined threshold (e.g., 90%), application of the inference processing can be started.

In the above-described exemplary embodiment, as illustrated in FIG. 5, the inference server 106 periodically executes the generation and update processing on the learning model. However, the present disclosure is not limited thereto. For example, the inference server 106 periodically evaluates the performance by using the trained model data and the data sets for evaluation, and may execute update and generation processing of the trained model based on a result of the evaluation. For example, the inference server 106 executes the update processing in a case where a correct answer rate falls below a predetermined threshold. In a case where the correct answer rate further decreases and falls below a second predetermined threshold, the inference server 106 may discard the current trained model and may build a new trained model.

Further, in the above exemplary embodiment, supervised learning is used for the generation of model data. However, the present disclosure is not limited thereto. For example, the learning model may be generated by combining the supervised learning and reinforcement learning. In such a case, a data set generated by combining teaching data and a surrounding condition is used as data for pre-learning. In this case, the inference server 106 generates demonstration data based on the data set generated by combining teaching data on its surrounding environment and its surrounding condition. This demonstration data serves as a foothold in the early stage of learning using the reinforcement learning. When pre-learning based on the demonstration data is completed with respect to a value function and a policy, the processing proceeds to a phase of reinforcement learning and inference based on actual data. In other words, the inference server 106 generates a model in the early stage of learning by executing imitation learning equivalent to supervised learning. In the phase of reinforcement learning and inference, the inference server 106 determines to execute some sort of action for traffic steering determined based on the Markov decision process. The AP 101 and the other follower APs execute traffic steering based on the action. The STAs and the APs measure communication conditions before and after executing the traffic steering. Based on the measurement result, the inference server 106 evaluates a result of the traffic steering.

The inference server 106 promptly gives rewards to agent based on evaluated effects of the traffic steering, and updates the value function. The inference server 106 can execute additional learning by repeatedly executing these processes. In this reinforcement learning, there is a case where new action that has not been tried in teaching data is selected and executed because the action is selected based on the Markov decision process. The inference server 106 evaluates behavior and adjusts the policy of the agent based also on an actual result obtained by executing the new action. Accordingly, as the additional learning proceeds, the policy of the agent is adjusted so that the policy is evaluated in the real environment. The value function is updated based on passage of time and observed evaluation, the agent selects not only short-term behavior but also proactive behavior. With the use of the reinforcement learning in this way, actions that lead to “ping-pong roaming” in which steering is repeated such that one AP presses the STA against another AP are less likely to be valued as the learning proceeds and are hardly to be selected as a policy. Even if traffic is temporarily improved as a result of the actions, the actions having a negative effect on another follower AP as time passes are less likely to be valued as the learning proceeds and are hardly to be selected as the policy. As described above, the above exemplary embodiment is modifiable as appropriate so as to build a model through the reinforcement learning, update a model, and execute inference.

The present disclosure can be realized through the processing in which a program for implementing one or more functions according to the above-described exemplary embodiments is supplied to a system or an apparatus via a network or a storage medium, so that a computer in the system or the apparatus reads and executes the program. The computer has one or a plurality of processors or circuits, and may include a plurality of separated computers, a plurality of separated processors, or circuit networks, in order to read and execute a computer-executable instruction.

The processor or the circuit may include a central processing unit (CPU), a micro processing unit (MPU), a graphics processing unit (GPU), an application specific integrated circuit (ASIC), and a FPGA. The processor or the circuit may include a digital signal processor (DSP), a data flow processor (DFP), or a neural processing unit (NPU).

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, it is possible to execute traffic steering capable of optimizing end-to-end communication in a wireless communication apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A communication apparatus comprising:
at least one memory storing instructions; and
at least one processor configured to execute the instructions stored in the at least one memory to cause the communication apparatus to:
transmit, to a server, an inference request including all or part of information about quality of a wireless channel, information indicating conditions of loads of a plurality of access points, information about a characteristic of traffic, and time-series data on any of the foregoing pieces of information in a unit of time, wherein the inference request requests inference of quality of communication with another communication apparatus in a case where traffic steering processing for tuning at least any one of a connection state and a communication path between the communication apparatus and the another communication apparatus is executed;
acquire a result of inference of the quality of the communication from the server;
determine whether to execute the traffic steering based on the result of the inference; and
provide information about change of the communication to the another communication apparatus in a case where the communication apparatus determines to execute the traffic steering.

2. The communication apparatus according to claim 1, wherein the quality of the communication is inferred by the server based on the information included in the inference request and trained model data stored by the server.

3. A control method, by a communication apparatus, for performing control relating to traffic steering, the control method comprising:
transmitting, to a server, an inference request including all or part of information about quality of a wireless channel, information indicating conditions of loads of a plurality of access points, information about a characteristic of traffic, and time-series data on any of the foregoing pieces of information in a unit of time, wherein the inference request requests inference of quality of communication by the communication apparatus with another communication apparatus in a case where traffic steering processing for tuning at least any one of a connection state and a communication path between the communication apparatus and the another communication apparatus is executed;
acquiring a result of inference of the quality of the communication from the server;
determining whether to execute the traffic steering based on the result of the inference; and
providing information about change of the communication to the another communication apparatus in a case where the first communication apparatus determines to execute the traffic steering.

4. A non-transitory computer readable storage medium storing a program to cause a computer to perform:
transmit, to a server, an inference request including all or part of information about quality of a wireless channel, information indicating conditions of loads of a plurality of access points, information about a characteristic of traffic, and time-series data on any of the foregoing pieces of information in a unit of time, wherein the inference request requests inference of quality of communication with a second communication apparatus in a case where traffic steering processing for tuning at least any one of a connection state and a communication path between a first communication apparatus and the second communication apparatus is executed;
acquire a result of inference of the quality of the communication from the server;
determine whether to execute the traffic steering based on the result of the inference; and
provide information about change of the communication to the second communication apparatus in a case where the first communication apparatus determines to execute the traffic steering.
